(19) United States
(12) Patent Application Publication
(10) Pub. No.: US 2019/0078668 A1
(43) Pub. Date: Mar. 14, 2019

(54) Powersplit Powertrains Having Dual Ball-Type Continuously Variable Transmission

(71) Applicant: Dana Limited, Maumee, OH (US)

(72) Inventors: Jeffrey M. David, Leander, TX (US); T. Neil McLemore, Leander, TX (US); Travis J. Miller, Leander, TX (US)

(21) Appl. No.: 16/124,634

(22) Filed: Sep. 7, 2018

Related U.S. Application Data
(60) Provisional application No. 62/558,783, filed on Sep. 14, 2017.

(51) Int. Cl. F16H 15/50; F16H 3/44; F16H 37/02

(52) U.S. Cl. CPC F16H 15/503; F16H 2200/2005; F16H 37/022; F16H 3/44

(57) ABSTRACT

A powertrain including: a main shaft; a first variator having a first plurality of balls in contact with a first traction ring assembly and a second traction ring assembly, and each ball operably coupled to a first carrier assembly; a second variator having a second plurality of balls in contact with a third traction ring assembly and a fourth traction ring assembly, and each ball operably coupled to a second carrier assembly; and a planetary gear set having a ring gear, a planet carrier supporting a plurality of planet gears coupled to the ring gear, and a sun gear coupled to the plurality of the planet gears. The first variator, second variator, and planetary gear set are arranged coaxially along the main shaft. The first traction ring assembly is coupled to the planetary gear set and the second traction ring assembly is coupled to the third traction ring assembly.

### RELATED APPLICATIONS

This application claims benefit from and priority to U.S. Provisional Patent Application No. 62/558,783 filed on Sep. 14, 2017, which is herein incorporated in by reference in its entirety.

### BACKGROUND

A driveline including a continuously variable transmission allows an operator or a control system to vary a drive ratio in a stepless manner, permitting a power source to operate at its most advantageous rotational speed.

### SUMMARY

Provided herein is a powertrain including: a main shaft; a first variator having a first plurality of balls, each ball provided with a tiltable axis of rotation, each ball in contact with a first traction ring assembly and a second traction ring assembly, and each ball operably coupled to a first carrier assembly; a second variator having a second plurality of balls, each ball provided with a tiltable axis of rotation, each ball in contact with a third traction ring assembly and a fourth traction ring assembly, and each ball operably coupled to a second carrier assembly; and a planetary gear set having a ring gear, a planet carrier supporting a plurality of planet gears coupled to the ring gear, and a sun gear coupled to the plurality of the planet gears, wherein the first variator, the second variator, and the planetary gear set are arranged coaxially along the main shaft, and wherein the first traction ring assembly is operably coupled to the planetary gear set, and the second traction ring assembly is operably coupled to the third traction ring assembly.

In some embodiments, the planet carrier is adapted to receive an input power.

In some embodiments, the ring gear is operably coupled to the first traction ring assembly.

In some embodiments, the sun gear is operably coupled to the first traction ring assembly.

In some embodiments, the fourth traction ring assembly is operably coupled to the sun gear.

In some embodiments, the fourth traction ring assembly is operably coupled to the ring gear.

In some embodiments, the first carrier assembly and the second carrier assembly are operably coupled to a ground.

In some embodiments, the powertrain includes a fixed ratio gear set operably coupled between the second traction ring assembly and the third traction ring assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the present invention will be obtained by reference to the following detailed description that sets forth illustrative embodiments, in which the principles of the embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic lever diagram of a powertrain having two ball-type variators and a planetary gear set arranged in a powersplit configuration.

FIG. 5 is a schematic lever diagram of another powertrain having two ball-type variators and a planetary gear set arranged in a powersplit configuration.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the embodiments include several novel features, no single one of which is solely responsible for its desirable attributes or which is essential to practicing the embodiments described.

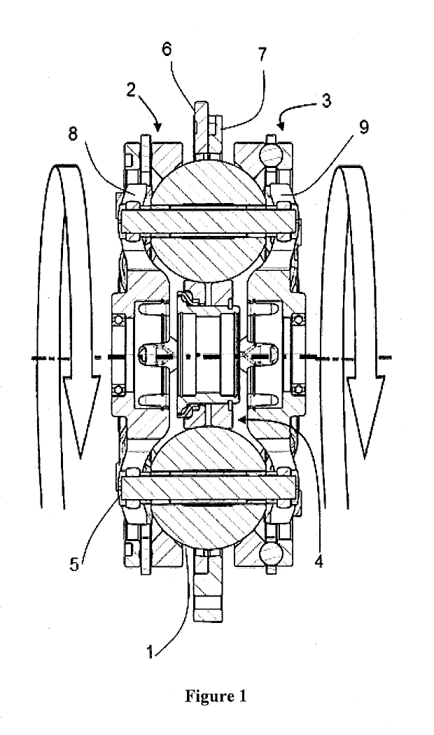

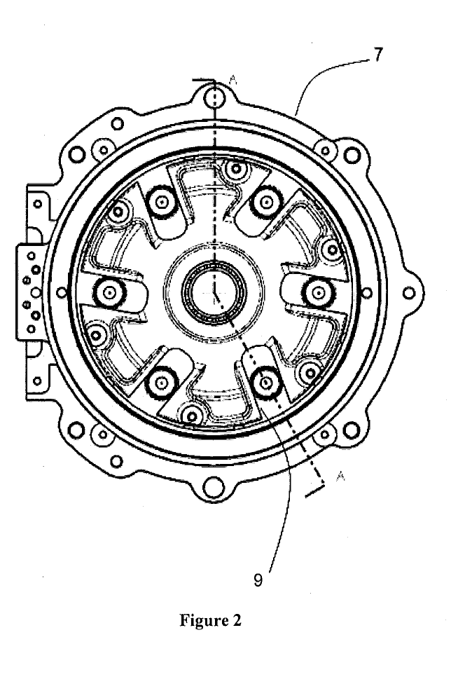

Provided herein are configurations of Continuously Variable Transmissions (CVTs) based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, an input (first) 2 and output (second) 3, and an idler (sun) assembly 4 as shown on FIG. 1. Sometimes, the input ring 2 is referred to in illustrations and referred to in text by the label “R1”. The output ring 3 is referred to in illustrations and referred to in text by the label “R2”. The idler (sun) assembly 4 is referred to in illustrations and referred to in text by the label “S”. The balls are mounted on tiltable axles 5, themselves held in a carrier (stator, cage) assembly having a first carrier member 6 operably coupled to a second carrier member 7. Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

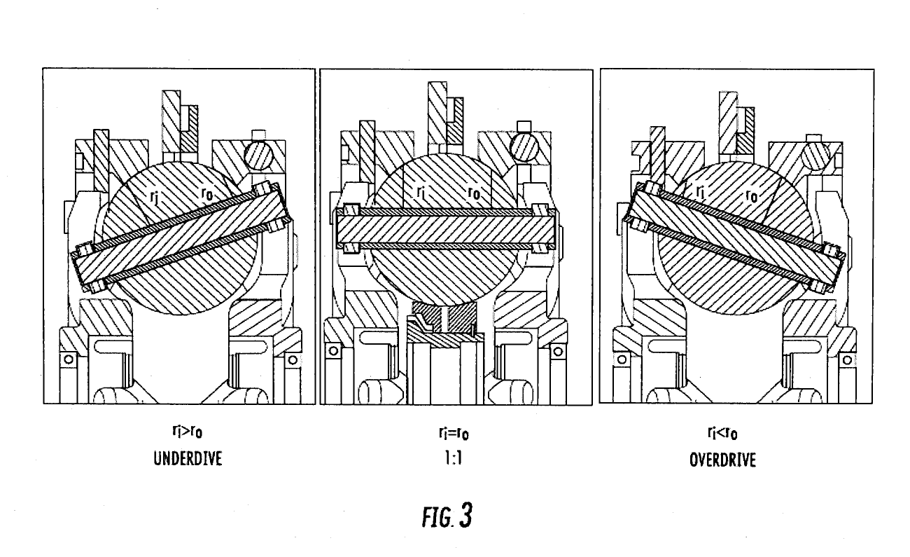

The working principle of such a CVP of FIG. 1 is shown on FIG. 3. The CVP itself works with a traction fluid. The lubricant (or traction fluid) between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The variator embodiments disclosed here can be controlled using generally spherical planets each having a tiltable axis of rotation that is adjusted to achieve a desired ratio of input speed to output speed during operation.

In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”.

In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT operates at times as a friction drive and at other times as a traction drive, depending on the torque and speed conditions present during operation.

For purposes of description, schematics referred to as lever diagrams are used herein. A lever diagram, also known as a lever analogy diagram, is a translational-system representation of rotating parts for a planetary gear system. In certain embodiments, a lever diagram is provided as a visual aid in describing the functions of the transmission. In a lever diagram, a compound planetary gear set is often represented by a single vertical line (“lever”). The input, output, and reaction torques are represented by horizontal forces on the lever. The lever motion, relative to the reaction point, represents direction of rotational velocities. For example, a typical planetary gear set having a ring gear, a planet carrier, and a sun gear is represented by a vertical line having nodes “R” representing the ring gear, node “S” representing the sun gear, and node “C” representing the planet carrier.

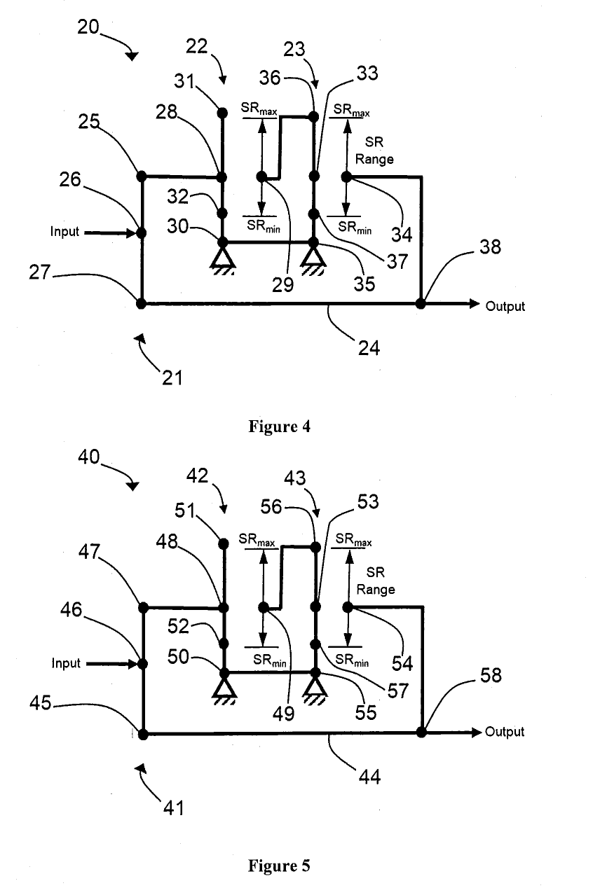

Referring to FIG. 4, in some embodiments, a powertrain 20 includes a planetary gear set 21, a first variator 22, and a second variator 23 arranged coaxially on a main shaft 24. For description purposes, the powertrain 20 is depicted as a lever diagram in FIG. 4.

In some embodiments, the planetary gear set 21 is a common planetary gear set that includes a ring gear 25, a planet carrier 26, and a sun gear 27. The planet carrier 26 supports a plurality of planet gears coupled to the ring gear 25 and the sun gear 27.

In other embodiments, the planetary gear set 21 is optionally configured to have other known configurations of gears.

In some embodiments, the planet carrier 26 receives an input power from a source of rotational power (not shown).

In some embodiments, the first variator 22 and the second variator 23 are similar to the variator described in reference to FIGS. 1-3.

In some embodiments, the first variator 22 includes a first traction ring assembly 28, a second traction ring assembly 29 and a first carrier assembly 30.

In some embodiments, the first carrier assembly 30 is coupled to a grounded, non-rotatable member of the powertrain 20.

The first variator 22 is configured to have a ratio range depicted on the lever diagram with a maximum ratio 31 and a minimum ratio 32.

In some embodiments, the ratios range from an underdrive ratio to an overdrive ratio, for example 0.5 to 2.0, however, it should be appreciated that a number of design factors can be adjusted to provide a desired ratio range of the variator.

The first traction ring assembly 28 is operably coupled to the ring gear 25. The second variator 23 includes a third traction ring assembly 33, a fourth traction ring assembly 34, and a second carrier assembly 35.

In some embodiments, the second carrier assembly 35 is coupled to the first carrier member 30.

In some embodiments, the second carrier assembly 35 is operably coupled to a grounded member of the powertrain 20.

The second variator 23 is configured to have a ratio range depicted on the lever diagram with a maximum ratio 36 and a minimum ratio 37.

In some embodiments, the ratios range from an underdrive ratio to an overdrive ratio, for example 0.5 to 2.0, however, it should be appreciated that a number of design factors can be adjusted to provide a desired ratio range of the variator.

In some embodiments, the second traction ring assembly 29 is operably coupled to the third traction ring assembly 33.

It should be appreciated that the coupling between the second traction ring assembly 29 and the third traction ring assembly 33 can include a variety of mechanical couplings that may include, but are not limited to, a fixed ratio gearset.

The fourth traction ring assembly 34 is operably coupled to the sun gear 27 at a node 38 where an output power is transmitted from the powertrain 20.

Referring to FIG. 5, in some embodiments, a powertrain 40 includes a planetary gear set 41, a first variator 42, and a second variator 43 arranged coaxially on a main shaft 44. For description purposes, the powertrain 40 is depicted as a lever diagram in FIG. 5.

In some embodiments, the planetary gear set 41 is a common planetary gear set that includes a ring gear 45, a planet carrier 46, and a sun gear 47. The planet carrier 46 supports a plurality of planet gears coupled to the ring gear 45 and the sun gear 47.

In other embodiments, the planetary gear set 41 is optionally configured to have other known configurations of gears.

In some embodiments, the planet carrier 46 receives an input power from a source of rotational power (not shown).

In some embodiments, the first variator 42 and the second variator 43 are similar to the variator described in reference to FIGS. 1-3.

In some embodiments, the first variator 42 includes a first traction ring assembly 48, a second traction ring assembly 49 and a first carrier assembly 50.

In some embodiments, the first carrier assembly 50 is coupled to a grounded, non-rotatable member of the powertrain 40.

The first variator 42 is configured to have a ratio range depicted on the lever diagram with a maximum ratio 51 and a minimum ratio 52.

In some embodiments, the ratios range from an underdrive ratio to an overdrive ratio, for example 0.5 to 2.0, however, it should be appreciated that a number of design factors can be adjusted to provide a desired ratio range of the variator.

The first traction ring assembly 48 is operably coupled to the sun gear 45.

In some embodiments, the second variator 43 includes a third traction ring assembly 53, a fourth traction ring assembly 54, and a second carrier assembly 55.

In some embodiments, the second carrier assembly 55 is coupled to the first carrier member 50.

In some embodiments, the second carrier assembly 55 is operably coupled to a grounded member of the powertrain 40.

The second variator 43 is configured to have a ratio range depicted on the lever diagram with a maximum ratio 56 and a minimum ratio 57.

In some embodiments, the ratios range from an underdrive ratio to an overdrive ratio, for example 0.5 to 2.0, however, it should be appreciated that a number of design factors can be adjusted to provide a desired ratio range of the variator.

In some embodiments, the second traction ring assembly 49 is operably coupled to the third traction ring assembly 53.

It should be appreciated that the coupling between the second traction ring assembly 49 and the third traction ring assembly 53 can include a variety of mechanical couplings that may include, but are not limited to, a fixed ratio gearset.

The fourth traction ring assembly 54 is operably coupled to the ring gear 45 at a node 58 where an output power is transmitted from the powertrain 40.

It should be appreciated that the first variator 22, 42 and the second variator 23, 43 are optionally provided as an integrated variator having a common carrier of the type disclosed in U.S. patent application Ser. No. 12/527,400, which is hereby incorporated by reference.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein are capable of being employed in practicing the invention. It is intended that the following claims define the scope of the invention and that methods and structures within the scope of these claims and their equivalents be covered thereby.

What is claimed is:

1. A powertrain comprising:
a main shaft;
a first variator having a first plurality of balls, each ball provided with a tiltable axis of rotation, each ball in contact with a first traction ring assembly and a second traction ring assembly, and each ball operably coupled to a first carrier assembly;
a second variator having a second plurality of balls, each ball provided with a tiltable axis of rotation, each ball in contact with a third traction ring assembly and a fourth traction ring assembly, and each ball operably coupled to a second carrier assembly; and
a planetary gear set having a ring gear, a planet carrier supporting a plurality of planet gears coupled to the ring gear, and a sun gear coupled to the plurality of the planet gears,
wherein the first variator, the second variator, and the planetary gear set are arranged coaxially along the main shaft, and
wherein the first traction ring assembly is operably coupled to the planetary gear set, and the second traction ring assembly is operably coupled to the third traction ring assembly.

2. The powertrain of claim 1, wherein the planet carrier is adapted to receive an input power.

3. The powertrain of claim 2, wherein the ring gear is operably coupled to the first traction ring assembly.

4. The powertrain of claim 2, wherein the sun gear is operably coupled to the first traction ring assembly.

5. The powertrain of claim 3, wherein the fourth traction ring assembly is operably coupled to the sun gear.

6. The powertrain of claim 4, wherein the fourth traction ring assembly is operably coupled to the ring gear.

7. The powertrain of claim 2, wherein the first carrier assembly and the second carrier assembly are operably coupled to a ground.

8. The powertrain of claim 1, further comprising a fixed ratio gear set operably coupled between the second traction ring assembly and the third traction ring assembly.
